(19) United States
(12) Patent Application Publication
(10) Pub. No.: US 2014/0105700 A1
(43) Pub. Date: Apr. 17, 2014

(54) Flexible Cutting Rail Guide

(71) Applicant: Michael J. Gunderson, Yakima, WA (US)

(72) Inventor: Michael J. Gunderson, Yakima, WA (US)

(21) Appl. No.: 13/652,092

(22) Filed: Oct. 15, 2012

(51) Int. Cl. B23C 9/00; B26D 7/00

(52) U.S. Cl. 409/132; 409/178

(57) ABSTRACT

An apparatus and method for cutting a workpiece or template from wood, plastic, or other media. The apparatus is a flexible cutting rail guide comprising a length of elastomer stock having a cross-section with at least one ninety-degree angle, the elastomer stock being securable to a workpiece or template media. Preferably, the elastomer stock is square in cross-section and has a durometer rating in the range of about 75 to 90. The method teaches the use of a flexible cutting rail guide, workpiece media, and a router to cut a workpiece, comprising the steps of a) defining the desired design shape on the template media; b) removably securing the flexible cutting rail guide to the template media; and, c) cutting the template media by guiding the router along the flexible cutting rail guide. The invention further provides a method for cutting two or more identically shaped workpieces using the pattern or template.

### BACKGROUND AND SUMMARY OF THE INVENTION

According to known methods, cutting simple or compound curves into media such as wood, plastic, or other compositions to shape a workpiece or create a template requires several steps. First, the design is drawn on the media with drafting tools such as French curves and other shapes, or is drawn freehand. Next, the design is cut out with a tool such as a band saw or jigsaw, leaving an adequate amount of material beyond the desired contour for the next step. Finally, the cut is sanded to obtain the desired finished contour.

While the above method is generally effective for shaping a workpiece or creating a template, there are limitations. When the size of the workpiece or template media is very large, it may be too cumbersome to cut out on a band saw. A jigsaw is not suitable for cutting thick stock, and relies entirely on the operator's dexterity for achieving a controlled cut.

Other methods and apparatus exist for cutting a workpiece or template using numerical controlled devices. However, these are typically used only in larger manufacturing operations. The majority of woodworkers and small industrial and commercial operations cannot afford the substantial cost of acquiring and maintaining such devices.

A need exists for a method and apparatus for cutting a workpiece or template that overcomes the limitations of the current methods. Products currently on the market attempt to meet that need. For example, the Fisch Flexi Curve is a curve template made of a relatively stiff plastic material with integral screw bosses, available in limited size and length options. The usefulness of the Fisch Flexi Curve is limited by its small bend radius. From a practical standpoint, the relative stiffness of the material requires that it be sold in lengths suitable for shipping, stocking and displaying for retail. Other products available include curve templates made of plastic or of vinyl-covered lead. As with the Fisch Flexi Curve, these products are available in limited lengths and have a limited bend radius.

The present invention provides an apparatus and method for cutting a workpiece or template from wood, plastic, or other media that overcomes the limitations of known methods and devices. The apparatus is a flexible cutting rail guide comprising an elastomer rod having a cross-section with at least one ninety-degree angle, the elastomer rod being securable to a workpiece or template media. Preferably, the elastomer rod is square in cross-section and has a durometer rating in the range of about 75 to 90. The method teaches the use of a flexible cutting rail guide, workpiece media, and a router to cut a workpiece, comprising the steps of a) defining the desired design shape on the template media; b) removably securing the flexible cutting rail guide to the template media; and, c) cutting the template media by guiding the router along the flexible cutting rail guide. The invention further provides a method for cutting two or more identically shaped workpieces using the pattern or template.

The invention provides several advantages over known methods and devices:
1. The finished contour cut according to the invention requires little or no finish sanding, thus saving time and improving the accuracy of the cut.
2. The flexible rail guide serves as a drafting aid in inscribing various designs, in addition to serving as a guide for the router.
3. Cutting out circles or other geometric shapes can be done at any infinitely adjustable sizes without the use of preset diametrical or elliptical templates or bulky trammels.
4. The flexible rail guide can be made in various cross-sectional sizes to allow the use of various sized routers currently available on the market.
5. The invention eliminates the use of either a jigsaw or band saw in cutting out the pattern.
6. The flexible rail guide can be easily stored in a coiled or hanging position. This is advantageous for shipping, in the warehouse, in the retail display, and in the workshop.
7. The flexible rail guide can be easily transported to the work site.
8. The flexible rail guide can be used on vertical, horizontal or overhead surfaces and even 3 dimensional surfaces.
9. Unlike known rigid template aids, the flexible rail guide of the present invention is made from a strong flexible elastomer unlikely to break.
10. Perhaps the most important feature of the invention is the savings in costs and time when eliminating extra fabrication steps. The savings increase when several design iterations are created during the product design and development phase.
11. The flexible rail guide also increases the range of applications for routers.
12. The method and apparatus of the present invention provides for the use of less expensive cutting apparatus for the removing of cutouts in countertops or similar applications.

### BRIEF DESCRIPTION OF THE DRAWINGS

FIG. 1 is a sectional view of flexible cutting rail guides secured to a board;

FIG. 2 is a side view of the flexible cutting rail guide; and

FIG. 3 is a plan view of the flexible cutting rail guide secured to a board.

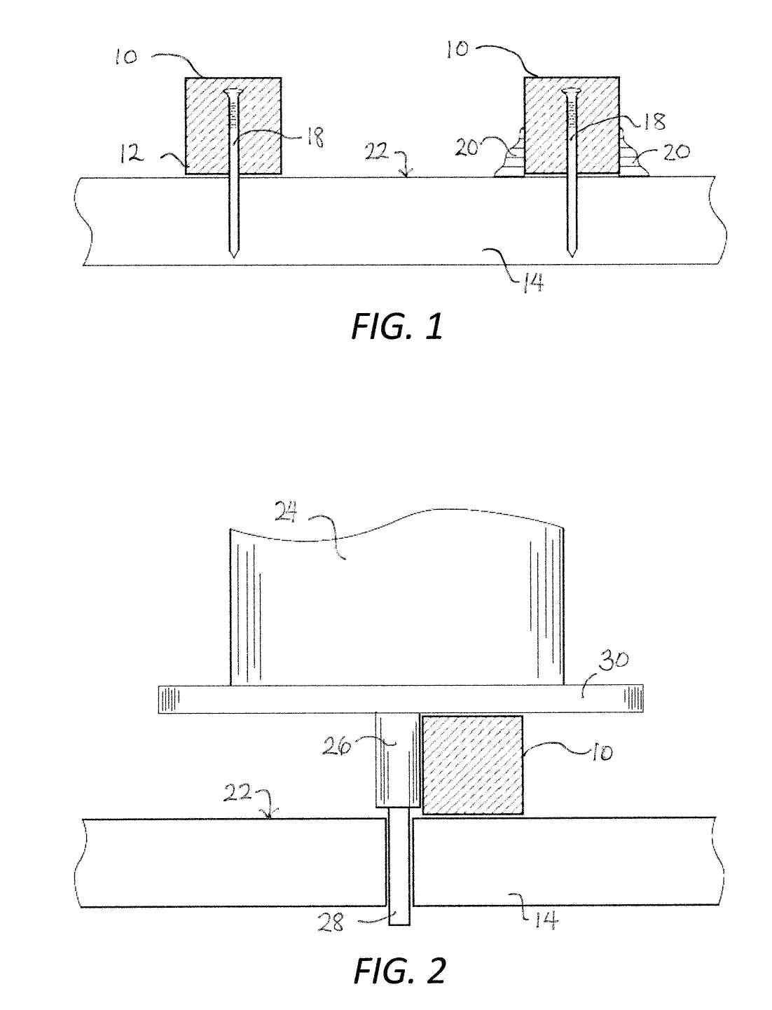

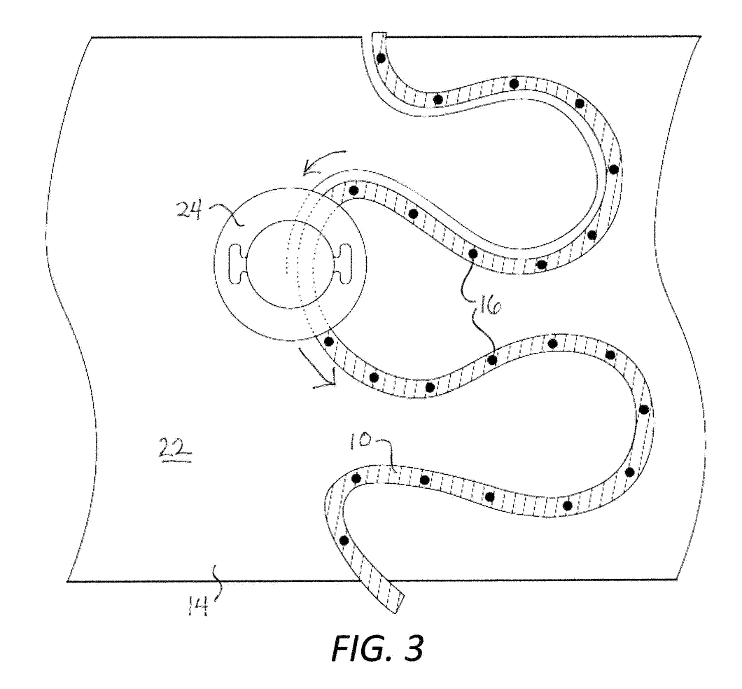

### DETAILED DESCRIPTION OF THE INVENTION

The present invention comprises a flexible cutting rail guide 10 useful in forming a curved design, and in guiding a router to cut a design in a pattern, template or workpiece. The flexible cutting rail guide (for simplicity, referred to herein as the “rail guide”) is made from an extruded hard rubber (elastomer) having a durometer rating in the range of about 55 to about 90. Preferably, the elastomer is a polyurethane elastomer having a durometer rating in the range of about 75 to about 90. The durometer rating in this range ensures a minimum of friction between the rail guide and the router, the significance of which will be made clear below, while at the same time allowing significant flexibility for forming curves and coiling the rail guide for storage. The length and width of the rail guide can be selected based on the needs of the user and the size of the router and template media or workpiece.

Preferably, the rail guide has at least one 90 degree angle 12 when viewed cross-sectionally. Most preferably, the cross-section is square, although a rectangular or “D” shaped cross section may also be useful in some applications.

The rail guide 10 is removably attachable to the template media or workpiece 14 with which it is used. Fasteners 18 are used to attach the rail guide. In one embodiment, the rail guide is attached to the template media or workpiece with fasteners that do not require pre-drilled holes, such as nails, staples or the like. In a preferred embodiment, the rail guide is affixed to the product surface using a pneumatic nailer. In an alternative embodiment, a plurality of fastener holes 16 are provided in the elastomer for receiving fasteners such as screws and the like therethrough. The holes may be counter-bored to ensure the fastener head does not extend above the rail guide surface. The fastener head must remain recessed below the surface to allow the router to slide unimpeded along the top of the rail while cutting the work piece. The number of screws or fasteners used is dictated by the degree of curvature in the design created by or traced with the rail guide. Tighter curves result in greater spring-back, and thus necessitate the use of a greater number of screws or fasteners to hold the rail guide in place. Conversely, open or loose curves require fewer screws or fasteners.

In an additional embodiment of the invention, hot-melt glue 20 is employed to removably attach the rail guide 10 to the template media or workpiece 14 instead of fasteners 18. Hot-melt glue can be removed with isopropyl alcohol or a scraper made from metal or wood. In an alternative embodiment, the rail guide is affixed to the workpiece with fasteners, as described above, and further secured with a bead of hot melt glue along the length of the rail guide, where the edge of the rail guide meets the work piece surface 22. When hot melt glue is used in the manner, it is removed by the router in the process of cutting the workpiece.

In addition to the rail guide 10 described herein, the present invention comprises a method for making a curved router template using the rail guide, and a method for cutting a curved design in two or more identically shaped workpieces 14 using the rail guide. In use, the rail guide is a simple, inexpensive and accurate tool for designing and cutting curved shapes in various materials used as workpieces, patterns, or templates. In general, two types of use are contemplated: cutting a single workpiece; and making a pattern or template for use in cutting two or more identically shaped workpieces.

To cut a single workpiece 14 according to the method of the invention, a curved design is first created on the back side of the workpiece media. The workpiece media can be selected from a variety of materials, including, but not limited to, wood, wood composites, plastic, stone, synthetic stone, fiberglass and the like. The design may be drawn free-hand, traced, or preferably, created using the rail guide 10 as a drafting spline.

Once the design has been created, the rail guide 10 is secured to the back side of the workpiece media 14 such that the edge of the rail guide is aligned with the line along which the cut will be made. Screws, nails, other fasteners 18, hot-melt glue 20, or a combination thereof may be employed to secure the rail guide to the workpiece. The length of the rail guide may be cut as needed to fit the design.

According to method of the invention, a wood router 24 such as is commonly used in woodworking and the like is used to cut the design by running the wood router along the rail guide 10, as shown by the directional arrow in FIG. 3. Preferably, the router is fitted with a router template guide 26 and an appropriate bit 28, typically a straight bit such as a pattern bit. To reduce friction between the router base 30 and the rail guide, silicone lubricant may be sprayed on the rail guide prior to cutting.

In an alternative embodiment, the disclosed method can also be used to cut a groove in the work piece.

To make a template for use in cutting two or more identically shaped workpieces, a curved design is first created on the template media, the rail guide 10 is attached thereto, and the design is cut, as described above, to create a template. The template can then be used as a guide to cut one or more workpieces.

The rail guide 10 described herein is a router accessory, and the methods described herein are methods for cutting materials in a desired configuration for a variety of end uses. The invention has application in furniture making, wherever a curved shape is desired, and in the artistic field where different visual effects using curved wood or plastic are desired. Other uses may be found in the advertising field, in the making of large signs for indoor or outdoor use, and large letters in an eye appealing font. Pattern making in the aerospace, automobile, and foundry industries would also benefit from the use of the present invention.

In addition to the above described applications, the apparatus and method of the present invention may be employed to cut out openings in tabletops made of various materials such as granite, marble, or engineered stone using a heavy duty plunge router. The invention can also be used to cut curved shapes in countertops using a router. When the rail guide 10 is mounted to the top or underside of the countertop slab with beads of hot-melt glue 20 on both sides of the rail guide as described herein, the entire area bounded by the rail guide can be flooded with water to allow the use of a diamond tipped router bit to cut the material in lieu of using a radial saw or hand held-grinder.

Using a router to cut ceramic tiles in a curve pattern is also possible with the rail guide, provided diamond bits are used.

In an alternative embodiment, two guide rails 10 are used together in double track configuration to provide stability to the router. This configuration is similar to a railcar, where wheel carriages are mounted underneath and can pivot with respect to the car body.

In compliance with the statutes, the invention has been described in language more or less specific as to structural features and process steps. While this invention is susceptible to embodiment in different forms, the specification illustrates preferred embodiments of the invention with the understanding that the present disclosure is to be considered an exemplification of the principles of the invention, and the disclosure is not intended to limit the invention to the particular embodiments described. Those with ordinary skill in the art will appreciate that other embodiments and variations of the invention are possible, which employ the same inventive concepts as described above. Therefore, the invention is not to be limited except by the following claims, as appropriately interpreted in accordance with the doctrine of equivalents.

I claim:

1. A method of making a router template using a flexible cutting rail guide, template media, and a router equipped with a router template guide, the method comprising the steps of:
a) defining the desired design shape on the template media;
b) removably securing the flexible cutting rail guide to the surface of the template media along the defined design shape; and,
c) cutting the template media by guiding the router along the flexible cutting rail guide.

2. The method of claim 1, wherein the step of defining the desired design shape is accomplished using the flexible cutting rail guide as a drafting spline.

3. The method of claim 1, wherein the flexible cutting rail guide is an elastomer having a durometer rating of about 55 to about 90.

4. The method of claim 1, wherein the flexible cutting rail guide is an elastomer having a durometer rating of about 75 to about 90.

5. A method of cutting two or more identically shaped workpieces from a workpiece media using a router equipped with a router template guide, and a router template comprising a flexible cutting rail guide and template media, the method comprising the steps of:
a) defining the desired design shape on the template media;
b) removably securing the flexible cutting rail guide to the template media along the defined design shape;
c) cutting the template media by guiding the router along the flexible cutting rail guide to form the router template;
d) removing the flexible cutting rail guide from the router template;
e) removably securing the router template on the workpiece media; and
f) cutting the workpiece media by guiding the router along the template edge to form the workpiece; and
g) repeating steps e) and f) for each identically shaped workpiece desired.

6. The method of claim 5, wherein the step of defining the desired design shape is accomplished using the flexible cutting rail guide as a drafting spline.

7. The method of claim 5, wherein the flexible cutting rail guide is an elastomer having a durometer rating of about 55 to about 90.

8. The method of claim 5, wherein the flexible cutting rail guide is an elastomer having a durometer rating of about 75 to about 90.

9. A flexible cutting rail guide for use in guiding a router to cut template or workpiece media, the flexible cutting rail guide comprising a length of elastomer stock having a cross-section with at least one ninety degree angle, the elastomer having a durometer rating in the range of about 55 to about 90.

10. The flexible cutting rail guide of claim 9, wherein the durometer rating is in the range of about 75 to about 90.

11. The flexible cutting rail guide of claim 9, wherein the elastomer is square in cross section.

12. The flexible cutting rail guide of claim 9, wherein a plurality of fastener holes are provided in the elastomer for receiving fasteners therethrough.

13. The flexible cutting rail guide of claim 9, further comprising a means for removably securing the elastomer to the media.
